(19) United States
(12) Patent Application Publication
(10) Pub. No.: US 2024/0099329 A1
(43) Pub. Date: Mar. 28, 2024

(54) Gingerbread House Construction Kit

(71) Applicant: Mark H. Weppner, Williamsville, NY (US)

(72) Inventor: Mark H. Weppner, Williamsville, NY (US)

(21) Appl. No.: 17/935,761

(22) Filed: Sep. 27, 2022

(51) Int. Cl. A23G 3/56; A21D 13/47; A21D 13/48; A21D 13/80

(52) U.S. Cl. CPC A23G 3/566; A21D 13/47; A21D 13/48; A21D 13/80

(57) ABSTRACT

A gingerbread house construction kit, comprising an easel having a front surface and a rear surface and a ledge extending outwardly from a bottom edge of the front surface, the easel also having at least one support member fixedly secured to the rear surface operatively arranged to support the easel on a flat surface such that the front surface makes an angle with respect to the flat surface; and, a plurality of gingerbread elements operatively arranged to be positioned and adhered to the front surface of the easel to create a gingerbread scene.

### FIELD

The present invention relates to a gingerbread house construction kit.

### BACKGROUND

Ginger root was reportedly first cultivated in China around 5,000 years ago. Although it has been known to function as a preservative for a very long time, some food historians believe that the first recipe for gingerbread dates to approximately 2400 B.C. in Greece, while others date it to Christian bakers in France in 992 A.D.

The tradition of decorating gingerbread houses began in Germany in the early 1800s. Some believe the tradition was bolstered by the Grimms' fairytale of Hansel and Gretel, published in 1812.

It is also known that Queen Elizabeth I's court created gingerbread biscuits in the shapes of important guests.

Today, the building and decorating of gingerbread houses is entrenched as a family-oriented holiday traditions in many parts of the world.

The building and decorating of gingerbread houses provide an edible artistic medium to children and adults alike. Gingerbread houses are commonly made to express creativity in a fun and visually vibrant medium around the holiday season, without being tied to any one religious celebration.

“Gingerbread” refers to a broad category of baked goods, typically flavored with ginger, cloves, nutmeg, and cinnamon and sweetened with honey, sugar, or molasses. Gingerbread foods vary, ranging from a soft, moist loaf cake to something close to a ginger snap. Recipes abound on the Internet and in cookbooks.

“Frosting” refers to a sweet topping that accompanies many baked goods, especially desserts. In its most basic form, frosting is the combination of sugar and some liquid such as water or milk, but there are hundreds of variations of frosting including blends of egg whites, butter, and a multitude of flavorings and colors. Some frostings also serve the function as an adhesive in gingerbread house construction.

Although gingerbread and frosting are probably the two main ingredients/components of traditional gingerbread houses, it should be appreciated that gingerbread houses, including those constructed with the present invention, may be constructed of a wide range of ingredients, including, but not limited to, icing, cookies, pretzels, licorice (strings, straws, chunks), non-pareils, graham crackers, graham cookies, ginger snaps, gumdrops, jelly candies, coated chocolate and peanut candies (M&Ms®), lollipops, chocolate-peanut butter cups, candy canes (traditional and logs), colored sugar, confectioners sugar, silver ball candies, chocolate chips, and candy sprinkles.

“Sprinkles” are tiny balls or rod-shaped bits of candy used as a topping for ice-cream, cakes and other sweet dishes, also frequently used in gingerbread house decoration.

As is well known, gingerbread houses are traditionally made using gingerbread as the base structural material, and then elements such as frosting, sprinkles and candy are added to add to the aesthetic. The frosting functions both as a cement or adhesive and as a base layer for other decorative items such as sprinkles, gumdrops and candy. Sometimes the gingerbread house is consumed, other times it is purely used as decoration. Gingerbread recipes vary, but common ingredients include butter, sugar, eggs, molasses, flour, baking soda, cinnamon, ginger, cloves, salt and water.

Gingerbread houses are notoriously difficult to construct, especially for young children. Aside from the foundation, typical constructions have six sides, of which two are quadrilateral walls, two are pentagonal walls, and two are quadrilateral roof panels. Kits may also include chimneys and other decorative elements such as Christmas trees, snowmen, snow, shrubs, bushes, stars, moon, sun, Santa sleigh, reindeer, garland, ornaments, and the like. The walls are typically affixed in multiple planes at approximately 90-degree angles when viewed from above, by using frosting as a bonding agent. Frosting has a reputation for being thin, or non-viscous until it sets or dries properly. Considering that the roof panels are also affixed using frosting as a bonding agent, the non-viscous nature can cause the roof panels to slide off, or the structure to fall apart in general, which can cause a great deal of frustration for children and adults who feel that such an endeavor should not be so difficult.

It is especially difficult for young children to construct and decorate a conventional gingerbread house as they often lack the manual dexterity necessary for the construction and decoration. As a result, what should be a fun holiday activity sometimes results in frustration and/or embarrassment for children.

Of course, physics also plays a role in gingerbread house construction. As is well known, a static friction force is the force required to cause an object to start sliding while a kinetic friction force is the force required to keep an object in motion as it slides along a surface. The static friction force tends to be greater than the kinetic friction force. The coefficient of static friction is equal to ratio of static friction force divided by the normal force created by the surfaces in contact with one another. Static friction coefficients have a range between 0 and 1, with values close to 0 indicating that relatively small forces will cause the object to slide while values close to 1 indicate that relatively larger forces will be required for the object to start to slide. It should be noted that the trigonometric tangent function of the angle at which the object starts to slide is equal to the static friction coefficient. A trigonometric tangent function of an angle that is 45 degrees is equal to 1. A static friction coefficient created between two objects at rest cannot be more than one. This means that, in order for an object to be held in place by another object at an angle greater than 45 degrees, at least one other force is required. All of these principles come into play when constructing a gingerbread house of vertical walls and sloping roofs.

Thus, there is a need for a gingerbread house construction kit that resolves the above-identified issues and solves the above-identified problems.

### SUMMARY OF THE INVENTION

The present invention generally comprises A gingerbread house construction kit, comprising an easel having a front surface and a rear surface and a ledge extending outwardly from a bottom edge of the front surface, the easel also having at least one support member fixedly secured to the rear surface operatively arranged to support the easel on a flat surface such that the front surface makes an angle with respect to the flat surface; and, a plurality of gingerbread elements operatively arranged to be positioned and adhered to the front surface of the easel to create a gingerbread scene.

The present invention further comprises a method for making a substantially 2-dimensional gingerbread scene on a front surface of an easel, comprising the steps of placing a first plurality of gingerbread materials on a front surface of the easel, the easel having a front surface and a back surface, wherein the front surface further comprises an upper edge and a lower edge, and a ledge that extends outwardly from the lower edge arranged to support some of the gingerbread materials, wherein the first plurality of gingerbread materials comprises frosting; and placing a second plurality of gingerbread materials upon the first plurality of gingerbread materials, wherein the first and second pluralities of gingerbread materials are placed in a position on the front surface during a construction phase, and the first and second pluralities of gingerbread materials will remain relatively in the same position during a curing phase.

The invention also includes a method for making a substantially 2-dimensional gingerbread scene on a front surface of an easel comprising the steps of placing a first plurality of gingerbread materials on a rear surface of a second plurality of gingerbread materials and then placing the combined materials on the front surface of the easel, the easel having a front surface and a back surface, wherein the front surface further comprises an upper edge and a lower edge, and a ledge that extends outwardly from the lower edge arranged to support some of the gingerbread materials, wherein the first plurality of gingerbread materials comprises frosting and the second plurality of gingerbread materials are selected from the group consisting of gingerbread, candy, cookies and sprinkles.

A primary object of the present invention is to allow for the making of relatively planar gingerbread art on a sturdy surface wherein the artist places the gingerbread materials in a desired position on the front surface of an easel during a construction phase, where the gingerbread materials remain relatively in the same position during a curing phase.

Another object of the present invention is to provide a method and article of manufacture that enable young children to create an aesthetically pleasing gingerbread scene.

These and other objects, features, and advantages of the present disclosure will become readily apparent upon a review of the following detailed description of the disclosure, in view of the drawings and appended claims.

### BRIEF DESCRIPTION OF DRAWINGS

Various embodiments are disclosed, by way of example only, with reference to the accompanying schematic drawings in which corresponding reference symbols indicate corresponding parts, in which:

FIG. 1 is a perspective view of a traditional 3-dimensional gingerbread house, constructed poorly by a young child;

FIG. 2 is a front perspective view of the easel component of the present invention;

FIG. 3 is a left rear perspective view of the easel shown in FIG. 2;

FIG. 4 is a right rear perspective view of the easel shown in FIG. 2;

FIG. 5 is a left-side view of the easel shown in FIG. 2;

FIG. 6 is a right-side view of the easel shown in FIG. 2;

FIG. 7 is an exploded view of the easel shown in FIG. 2;

FIG. 8a is a perspective view of the easel shown in FIG. 2 showing a few gingerbread elements being positioned and glued thereon;

FIG. 8b is a perspective view of the easel shown in FIG. 2 showing the gingerbread elements shown in FIG. 8a after they have been secured to the easel front surface;

FIG. 9 is a perspective view of the easel shown in FIG. 2 except showing a completely assembled gingerbread scene thereon; and,

FIG. 10 is an exploded view of the invention shown in FIG. 9.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

It should be understood that the term “relatively planar” is a descriptor used herein to define an object having three dimensions: width, height, and depth. “Relatively planar” objects have both width and height that correspond to a plane, while the depth is substantially less than both the width and height.

It should also be appreciated that examples provided herein may conclude with “etc.,” which should be interpreted to mean viable alternatives within the scope of the named examples, such that unnamed examples would be apparent to one having ordinary skill in the art.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

It should be appreciated that the embodiments as illustrated are only one of a variety of possible embodiments of the claimed invention. It should also be appreciated that directional adjectives, such as “upper,” “lower”, “right”, “left”, and similar variations, are to be interpreted in view of the corresponding drawings and are intended to be exemplary.

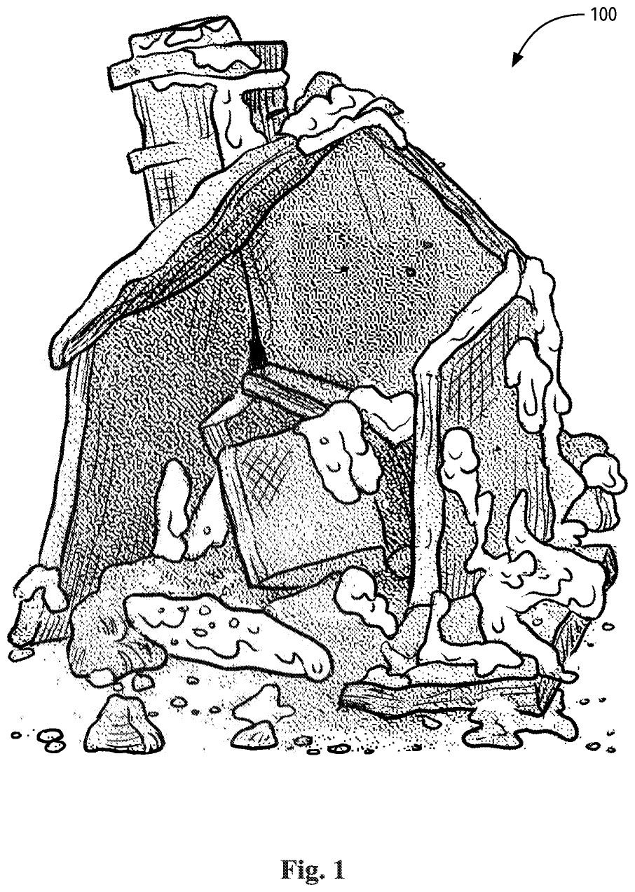

Adverting now to FIG. 1, this drawing is a perspective view of a traditional 3-dimensional gingerbread house 100, constructed poorly by a young child. As described previously young children and even some adults lack the manual dexterity and/or the artistic ability to construct a traditional gingerbread house, sometimes resulting in aesthetically displeasing houses and even collapsed walls or unstable structures.

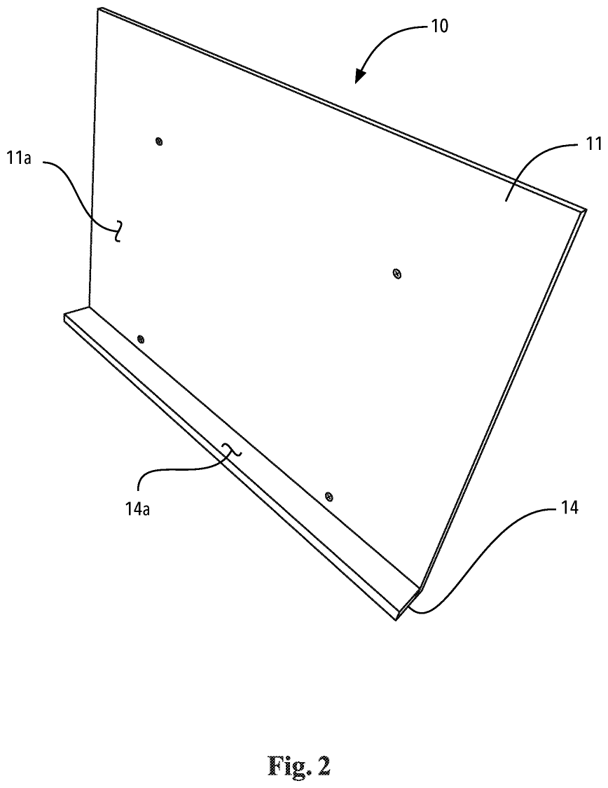

FIG. 2 is a front perspective view of easel 10 of the present invention. Easel 10 includes planar member 11, upper edge 12 and lower edge 13 and lower ledge 14, which is secured to the planar member at its lower edge 13 and extends outwardly therefrom. Ledge 14 has a top surface which functions to support placement of gingerbread house elements. Planar member 11 has a front surface 11a which functions as the mounting surface for edible gingerbread house elements as described infra (while it is envisioned that the gingerbread elements are edible, in some embodiments they don't have to be.) In a preferred embodiment, front surface 11a is substantially planar. Also in a preferred embodiment, planar member 11 is made of wood, but it could be made of plastic, metal, or any other suitable material. Planar surface 11a may also include printed indicia thereon such as a winter or holiday scene as described further infra.

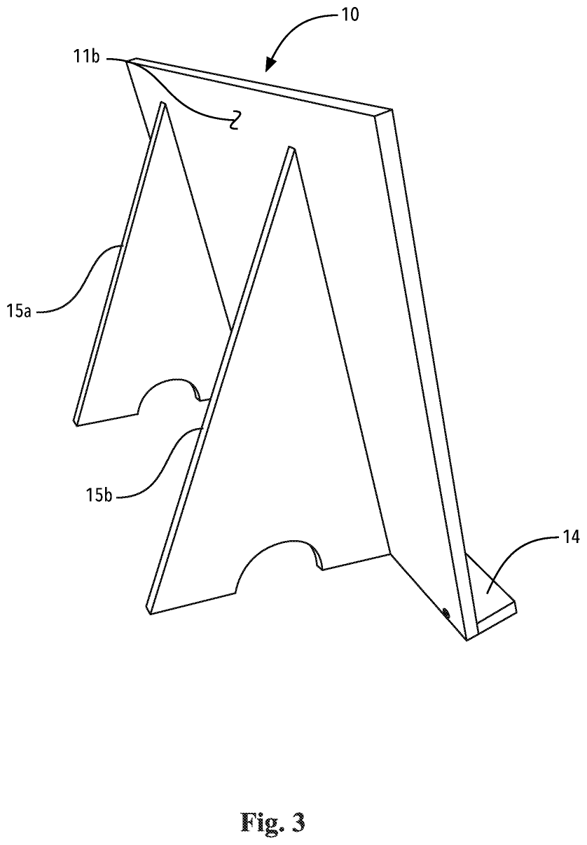

FIG. 3 is a left rear perspective view of the easel shown in FIG. 2. This drawing shows rear surface 11b of planar member 11. It also shows right base support 15a, left base support leg 15b, and ledge 14. The support legs are secured to planar member 11 with fasteners (screws) (identified infra) to support the member on a table or other surface. In a preferred embodiment, member 11 is supported at an angle of 72.9° although other angles are possible, preferably angles that are less than 90° and more than 30°. Obviously the lower the angle the less likely gingerbread elements are to slide or fall and the easier the task of constructing a 2-dimensional gingerbread house or scene will be. In a preferred embodiment, the angle of member 11 is fixed, but it is envisioned that adjustable support legs could be used to support member 11 in a way that could vary the angle of support as determined by the user.

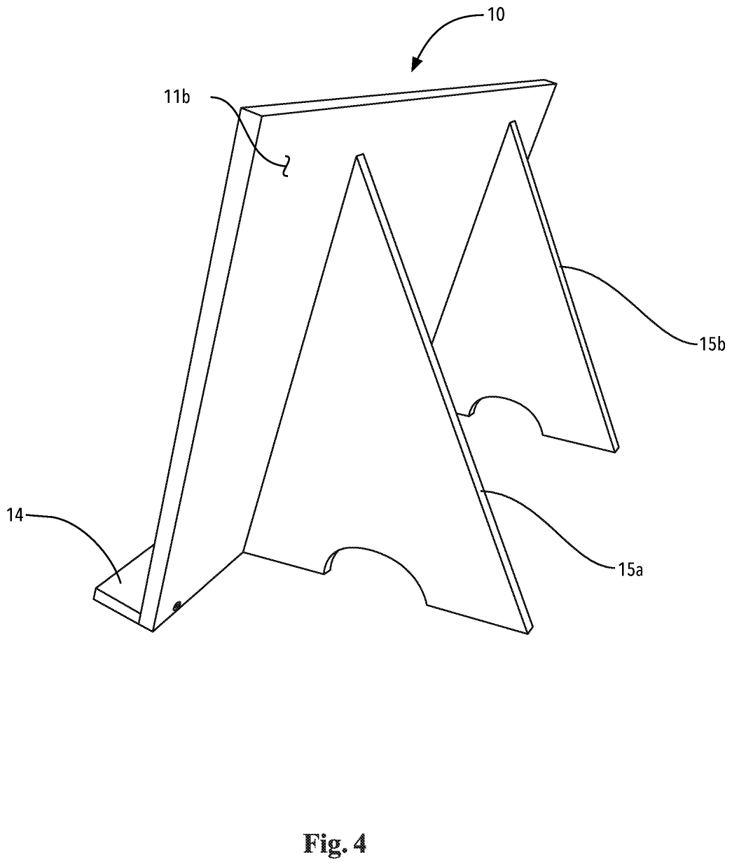

FIG. 4 is a right rear perspective view of the easel shown in FIG. 2. This drawing shows all the elements described above with respect to FIG. 3.

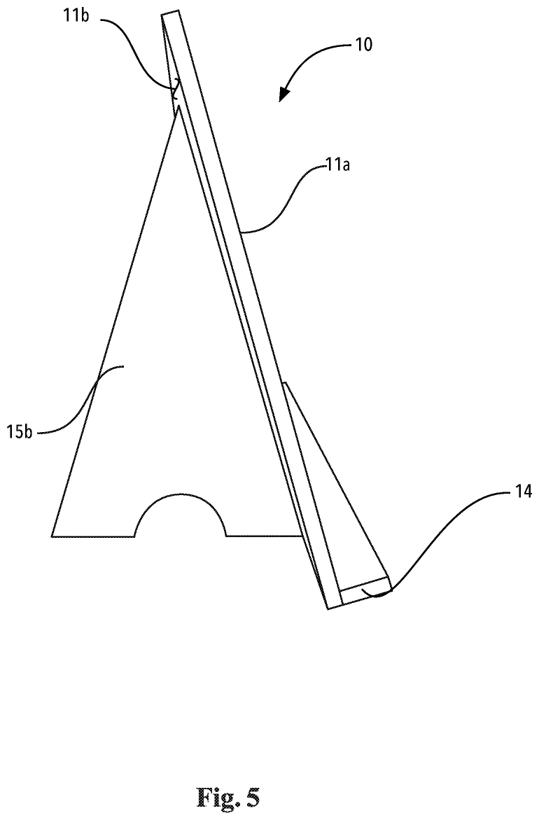

FIG. 5 is a left-side view of the easel shown in FIG. 2.

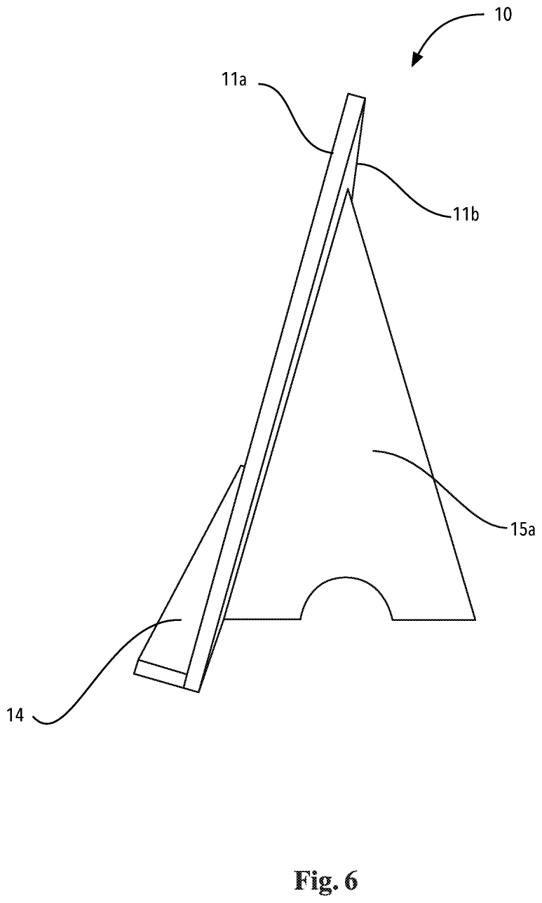

FIG. 6 is a right-side view of the easel shown in FIG. 2.

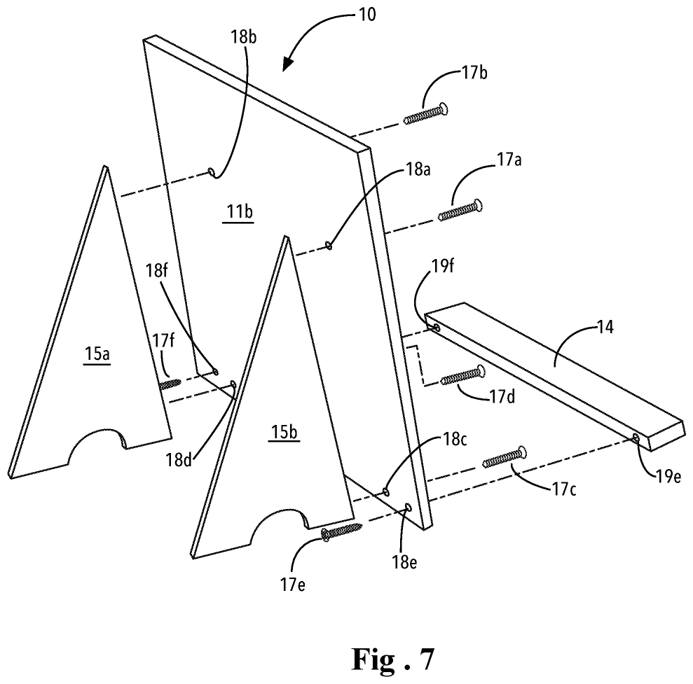

FIG. 7 is an exploded view of the easel shown in FIG. 2. As shown in the drawing, ledge 14 attaches to member 11 in the front and support legs 15a and 15b attach to member 11 in the rear. Member 11 includes through-bores 18a, 18b, 18c, 18d, 18e, and 18f. Fastener 17a is arranged to pass through through-bore 18a to secure support leg 15b to member 11. Fastener 17b is arranged to pass through through-bore 18b to secure support leg 15a to member 11. Fastener 17c is arranged to pass through through-bore 18c to secure support leg 15b to member 11. Fastener 17d is arranged to pass through through-bore 18d to secure support leg 15a to member 11. Fastener 17e is arranged to pass through through-bore 18e and into partial through-bore 19e in ledge 14 to secure ledge 14 to member 11. Fastener 17f is arranged to pass through through-bore 18f and into partial through-bore 19f in ledge 14 to secure ledge 14 to member 11. In a preferred embodiment, fasteners 17a, 17b, 17c, 17d, 17e, and 17f, are screws.

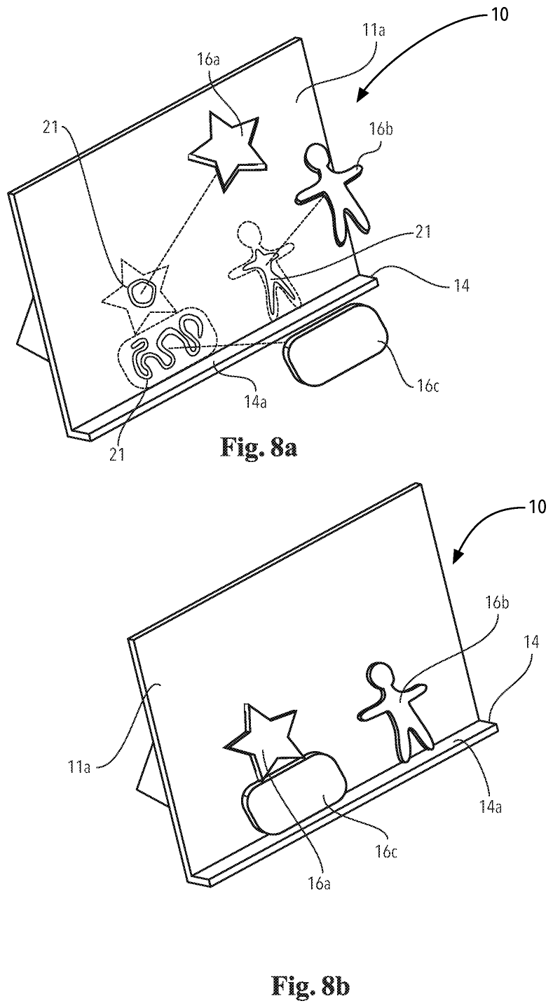

FIGS. 8a and 8b illustrate construction of a gingerbread scene on easel 10. As shown in FIG. 8a, the user would apply frosting 21 to surface 11a at various locations, and then place edible elements such as first edible element 16a (star), second edible element 16b (gingerbread man), and third edible element 16c (snow) onto the board atop the frosting. As the frosting dries during a curing stage it tends to become an adhesive to hold the edible elements in place on the front surface of the board. Again, it is preferred that the elements be edible but they don't have to be. Moreover and alternatively, the frosting/adhesive could be applied to a rear surface of one of the edible elements and then placed on surface 11a.

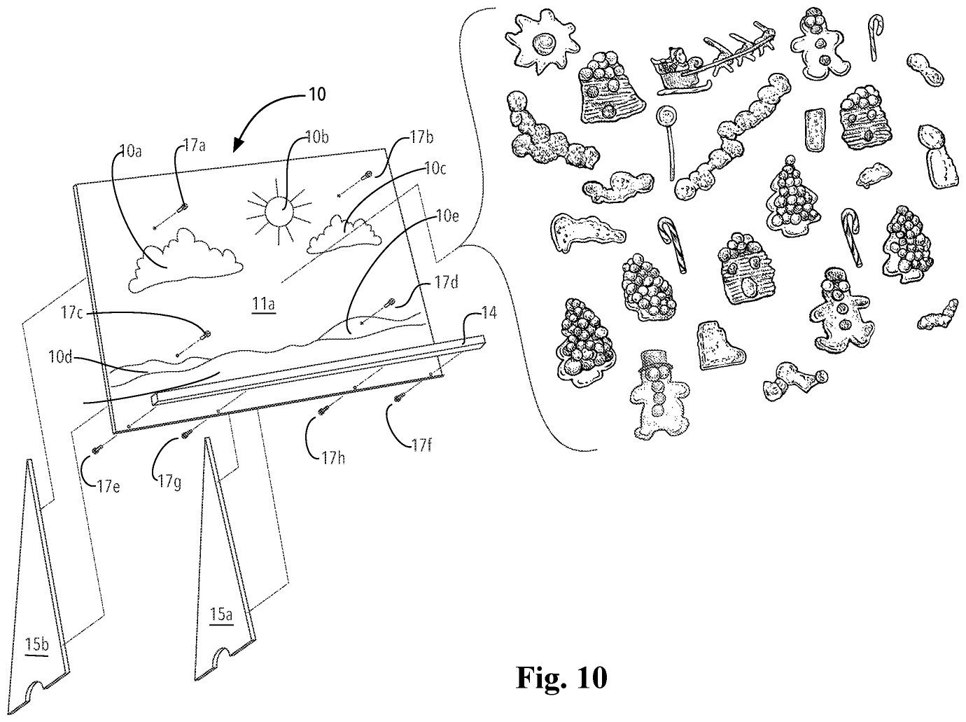

It should be appreciated that the order and position of placement of the edible elements placed on front surface 11a and upper surface 14a of lip 14 depend upon the user's artistic expression. There may be printed indicia on surface 11a, as described below in reference to FIG. 10, which may function as a guide to creation of a scene.

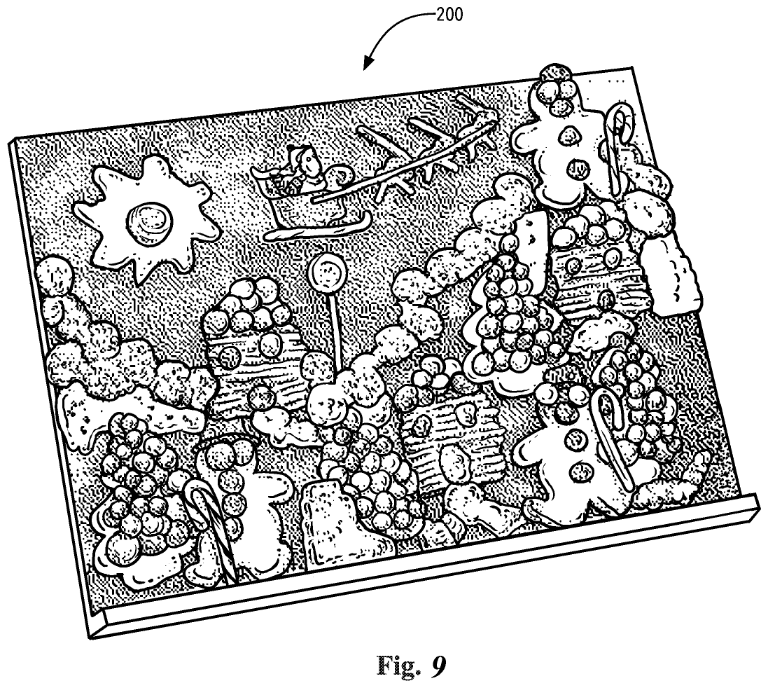

As can be seen in this drawing the completed scene is substantially 2-dimensional, since the individual gingerbread elements have length and width dimensions but small thickness dimensions relative to width and length. The resulting work of art differs from the traditional 3-dimensional gingerbread house both in appearance and in the complexity of manufacture. It should be appreciated by viewing the scene in FIG. 9 that any number of elements, such as but not limited to a Santa figure, a sleigh, reindeer, Christmas trees, snowmen, presents/gifts, bows, villages (house, cabin, store), igloos, animals, snowballs, snow, stars, sun, planets, moon, nativity scene (Jesus, Mary, Joseph, Manger, Wise Men, Three Kings, camels, sheep, donkey, other animals), drummer boy, bells, churches, wreaths, garland, and Advent wreath. A non-exhaustive list of possible artistic elements as shown in FIG. 9 are illustrated and shown in the table below:

FIG. 10 is an exploded view of the invention shown in FIG. 9. In addition to showing all the elements of the invention described supra, including the edible elements described in the table above, this drawing also shows printed indicia 10a (large cloud), 10b (sun), 10c (small cloud), 10d (small hills) and 10e (mountains). These printed indicia elements which are printed on front surface 11a of the easel function as a guide for the gingerbread scene maker, especially young children, in indicating where to place gingerbread elements on the surface of the easel. Obviously, a myriad of scenes are possible. Older children and adults may want to create their own printed indicia or use none at all. The possibilities are as endless as one's imagination.

It will be appreciated that various aspects of the present invention and other features and functions, or alternatives thereof, may be desirably combined into many other different systems or applications. For example, although the invention, in a preferred embodiment, provides a means and method for constructing a gingerbread scene to celebrate the Christmas holiday it should be appreciated that the invention could be used to construct other holiday scenes, including but not limited to Easter, Halloween and Thanksgiving, and could even be use to celebrate other special occasions such as birthdays, with substitution of appropriate building materials. Various presently unforeseen or unanticipated alternatives, modifications, variations, or improvements therein may be subsequently made by those skilled in the art which are also intended to be encompassed by the appended claims.

### LIST OF REFERENCE NUMERALS

10 Easel
10a Large cloud printed indicia
10b Sun printed indicia
10c Small cloud printed indicia
10d Small hills printed indicia
10e Mountains printed indicia
11 Planar member
11a Front surface of planar member 11
11b Rear surface of planar member 11a
12 Upper edge
13 Lower edge
14 Ledge
14a Upper surface of ledge 14
15a Right base support leg
15b Left base support leg
16a First edible element (star)
16b Second edible element (man)
16c Third edible element (snow)
17a Mechanical fastener
17b Mechanical fastener
17c Mechanical fastener
17d Mechanical fastener
17e Mechanical fastener
17f Mechanical fastener
18a Through-bore
18b Through-bore
18c Through-bore
18d Through-bore
18e Through-bore
18f Through-bore
19e Partial through-bore
19f Partial through-bore
21 Adhesive/frosting
200 Completed gingerbread scene

1. A gingerbread house construction kit, comprising:
an easel having a front surface and a rear surface and a ledge extending outwardly from a bottom edge of said front surface, said easel also having at least one support member fixedly secured to said rear surface operatively arranged to support said easel on a flat surface such that the front surface makes an angle with respect to said flat surface; and,
a plurality of gingerbread elements operatively arranged to be positioned and adhered to said front surface of said easel to create a gingerbread scene.

2. The gingerbread house construction kit recited in claim 1 wherein said angle is greater than 30° and less than 90°.

3. The gingerbread house construction kit recited in claim 2 wherein said angle is approximately 73°.

4. The gingerbread house construction kit recited in claim 1 wherein said plurality of gingerbread elements is selected from the group consisting of elements representative of Santa, a sleigh, reindeer, snowman, presents, gifts, bows, igloos, animals, snowballs, snow, stars, the sun, the moon, planets, fruit basket, candy cane, snow, lollipop, Christmas tree, boot, tinsel, villages (house, cabin, store), nativity scene (Jesus, Mary, Joseph, Manger, Wise Men, Three Kings, camels, sheep, donkey, other animals), drummer boy, bells, churches, wreaths, garland and Advent wreath.

5. The gingerbread house construction kit recited in claim 1 wherein said easel comprises two rear support members, including a right support member secured to said rear surface and a left rear support member secured to said rear surface.

6. The gingerbread house construction kit recited in claim 1 wherein said front surface further comprises at least one printed indicia scene element which functions to guide a user as to placement of said gingerbread elements.

7. The gingerbread house construction kit recited in claim 1 wherein said gingerbread elements are edible.

8. The gingerbread house construction kit recited in claim 1 wherein at least some of said gingerbread elements are made of gingerbread.

9. The gingerbread house construction kit recited in claim 1 wherein at least one of said gingerbread elements comprises frosting, wherein said frosting functions as an adhesive to secure said gingerbread elements to said front surface.

10. The gingerbread house construction kit recited in claim 1 wherein at least some of said gingerbread elements are selected from the group consisting of icing, cookies, pretzels, licorice (strings, straws, chunks), non-pareils, graham crackers, graham cookies, ginger snaps, gumdrops, jelly candies, coated chocolate and peanut candies (M&Ms®), lollipops, chocolate-peanut butter cups, candy canes (traditional and logs), colored sugar, confectioners sugar, silver ball candies, chocolate chips, and candy sprinkles.

11. The gingerbread house construction kit recited in claim 1 wherein said flat surface is a top surface of a table.

12. The gingerbread house construction kit recited in claim 1 where said easel has an upper edge and a lower edge and said ledge is affixed to said front surface of said easel proximate said lower edge and extends outwardly therefrom.

13. A method for making a substantially 2-dimensional gingerbread scene on a front surface of an easel, comprising the steps of:
placing a first plurality of gingerbread materials on a front surface of said easel, said easel having a front surface and a back surface, wherein the front surface further comprises an upper edge and a lower edge, and a ledge that extends outwardly from said lower edge arranged to support some of said gingerbread materials, wherein said first plurality of gingerbread materials comprises frosting;
placing a second plurality of gingerbread materials upon said first plurality of gingerbread materials, wherein said first and second pluralities of gingerbread materials are placed in a position on the front surface during a construction phase and said first and second pluralities of gingerbread materials remain relatively in the same position during a curing phase.

14. The method for making a substantially 2-dimensional gingerbread scene on a front surface of an easel as recited in claim 13 wherein said second plurality of gingerbread materials are selected from the group consisting of cookies, pretzels, licorice (strings, straws, chunks), non-pareils, graham crackers, graham cookies, ginger snaps, gumdrops, jelly candies, coated chocolate and peanut candies (M&Ms®), lollipops, chocolate-peanut butter cups, candy canes (traditional and logs), colored sugar, confectioners sugar, silver ball candies, chocolate chips, and candy sprinkles.

15. A method for making a substantially 2-dimensional gingerbread scene on a front surface of an easel, comprising the steps of:
placing a first plurality of gingerbread materials on a rear surface of a second plurality of gingerbread materials and then placing the combined materials on said front surface of said easel, said easel having a front surface and a back surface, wherein the front surface further comprises an upper edge and a lower edge, and a ledge that extends outwardly from said lower edge arranged to support some of said gingerbread materials, wherein said first plurality of gingerbread materials comprises frosting and said second plurality of gingerbread materials are selected from the group consisting of cookies, pretzels, licorice (strings, straws, chunks), non-pareils, graham crackers, graham cookies, ginger snaps, gumdrops, jelly candies, coated chocolate and peanut candies (M&Ms®), lollipops, chocolate-peanut butter cups, candy canes (traditional and logs), colored sugar, confectioners sugar, silver ball candies, chocolate chips, and candy sprinkles.
